(19) United States
(12) Patent Application Publication
(10) Pub. No.: US 2007/0173552 A1
(43) Pub. Date: Jul. 26, 2007

(54) Nanoporous polymer foams from hardening of reactive resins in microemulsion

(75) Inventors: Volker Schadler, Maikammer (DE); Moritz Ehrenstein, Ludwigshafen (DE); Cedric Du Fresne von Hohenesche, Mainz (DE)

Correspondence Address: CONNOLLY BOVE LODGE & HUTZ LLP, P.O. BOX 2207, WILMINGTON, DE, 19899-2207, US

(73) Assignee: BASF Aktiengesellschaft, Ludwigshafen (DE)

(21) Appl. No.: 10/595,844

(22) PCT Filed: Nov. 12, 2004
(86) PCT No.: PCT/EP04/12846

§ 371 Date: May 16, 2006

(30) Foreign Application Priority Data
Nov. 17, 2003 (DE) 103 53 745.7

(51) Int. Cl. C08J 9/28

(52) U.S. Cl. 521/65

(57) ABSTRACT

Nanoporous polymer foams, obtainable by curing microemulsions. The microemulsion comprises an aqueous reactive resin phase, a suitable amphiphile and an oil phase, and the reactive components may be subjected to a polycondensation. In a subsequent drying operation, the thus obtained gel particles are freed of the fluid components.

The invention relates to nanoporous polymer foams, obtainable by curing microemulsions. The microemulsion comprises an aqueous reactive resin phase, a suitable amphiphile and an oil phase, and the reactive components may be subjected to a polycondensation. In a subsequent drying operation, the thus obtained gel particles are freed of the fluid components.

Nanoporous polymer foams having a pore size of distinctly below 1 μm and a total porosity of above 90% are particularly outstanding thermal insulators on the basis of theoretical considerations.

Porous polymers having pore sizes in the range of 10-1000 nm are known and obtainable, for example, by polymerizing microemulsions (H.-P. Hentze and Markus Antonietti: Porous Polymers in Resins, 1964-2013, Vol. 5 in “Handbook of Porous Solids” Wiley, 2002).

Copolymerization in microemulsions of methyl methacrylate, ethylene glycol dimethacrylate and acrylic acid leads to open-celled polymer gels having honeycomblike, bicontinuous structures. However, as a consequence of phase separation effects during the polymerization, the pore size of the resulting porous structure is considerably greater than that of the microemulsion and is in the range of 1-4 μm (W. R. P. Raj J. Appl. Polym. Sci. 1993, 47, 499-511). In general, polymerization in microemulsions leads to the loss of the length scale, characteristic for the microemulsion, of a few 10s to 100s of nm. Additionally, materials of this type are unsuitable as thermal insulators, since they have very high bulk densities (low porosities).

In order to obtain polymer foams from the polymer gels, the fluid components, generally water, have to be removed, which generally leads, as a consequence of the high capillary forces and low stability of the gels in nanoporous materials, to extensive shrinkage of the polymer foam. A possible approach to the prevention of the high capillary forces in the course of drying is the use of supercritical fluids: aerogels having pores of <100 nm are obtainable, for example, by drying with supercritical CO₂. However, since the use of supercritical fluids is technically very complicated and generally associated with several solvent changes, alternative processes avoiding supercritical fluids are of great interest. Nanoporous polymer foams having a pore size of distinctly below 1 μm and a total porosity of over 90% are currently unobtainable without supercritical fluids.

It is therefore an object of the present invention to provide nanoporous polymer foams having extremely small pores and high total porosity. In addition, the intention is to find a process which enables drying of the polymer gel with low energy consumption and high space-time yields. The present application therefore provides materials which can be produced without supercritical fluids.

Accordingly, the above-described nanoporous polymer foams have been found which have been obtained, in a first step, by curing microemulsions consisting of an aqueous polycondensation-reactive resin phase, a suitable amphiphile and an oil phase. In a second step, the cured microemulsions are dried without using supercritical fluids.

In a preferred process, the nanoporous polymer foams may be prepared by the following stages:
a) providing a water-soluble polycondensation resin
b) preparing a microemulsion comprising an oil phase, a suitable amphiphile and an aqueous solution comprising auxiliaries, for example catalyst and curing agent for the polycondensation resin,
c) combining the polycondensation resin from stage a) with the microemulsion from stage b) and curing the microemulsion,
d) drying by evaporating the fluid constituents.

The microemulsion may be produced by known processes using ionic or nonionic surfactants. Of particular significance here are efficient amphiphiles which are capable of forming bicontinuous structures in low concentration.

In addition, reactive amphiphiles are of great advantage for the maintenance of the microemulsion structure during the polymerization, since they secure the interface. A useful reactive amphiphile may be a surfactant comprising amino groups, preferably an amphiphilic melamine derivative.

In the polycondensation-reactive resin phase, the microemulsion comprises a water-soluble polycondensation resin, preferably an unmodified or etherified amino resin, for example a urea-formaldehyde, benzoguanamine-formaldehyde or melamine-formaldehyde resin, or a mixture of various polycondensation-reactive resins. Particular preference is given to a melamine-formaldehyde resin modified by an alcohol and having a melamine/formaldehyde ratio in the range from 1/1 to 1/10, preferably from 1/2 to 1/6.

The oil component used may be a nonpolar compound such as hydrocarbons, alcohols, ketones, ethers or alkyl esters, which preferably have a boiling point at atmospheric pressure below 120° C. and can be readily removed from the polymer gel by evaporation. Examples thereof are linear or branched hydrocarbons having from 1 to 6 carbon atoms, in particular pentane, hexane or heptane.

The type and amount of the catalyst depend upon the polycondensation resin used. For amino resins, for example, organic or inorganic acids, e.g. phosphoric acid or carboxylic acids such as acetic acid or formic acid, may be used. Combinations with salts are also helpful in the control of the reaction kinetics.

In addition, crosslinking components (curing agents) may be used, for example urea or 2,4-diamino-6-nonyl-1,3,5-triazine in the case of melamine-formaldehyde resins.

The combination of the polycondensation-reactive resin, the amphiphile, the catalyst components, the oil component and the amount of water required to set the desired structure thus provides a curable microemulsion whose microstructure is substantially preserved during the polycondensation of the reactive components.

The ratio of the overall aqueous phase to the overall oil phase (W/O ratio) is generally 95/5-5/95, preferably 80/20-20/80.

The nanoporous polymer foams obtainable after drying the cured microemulsions feature high overall porosity and associated low bulk density and small pore size. The bulk density is preferably in the range from 5 to 200 g/l and the average pore diameter in the range from 10 to 1000 nm, preferably in the range from 30 to 300 nm. The inventive nanoporous polymer foams have low thermal conductivity, generally below 33 mW/m K and are therefore particularly suitable for thermal insulation applications such as insulation panels in the construction sector, cooling units, vehicles or industrial plants.

### EXAMPLES

### Example 1

Mixing of 10 g of heptane, 2.5 g of Lutensol TO7, 0.2 g of NH₄Cl and 13 g of 2% by weight aqueous phosphoric acid at 60° C. gave a microemulsion in the form of a clear, slightly opalescent, low-viscosity liquid.

2.5 g of an etherified melamine resin (Luwipal 063), preheated to 60° C., were added to this reaction catalyst-comprising microemulsion. After 20 minutes at 60° C., a slightly cloudy, highly viscous gel formed and was freeze-dried to remove the heptane.

### Example 2

Mixing of 10 g of pentane, 1.8 g of Lutensol TO7, 0.1 g of NH₄Cl and 16 g of 2% by weight aqueous phosphoric acid at 60° C. gave a microemulsion in the form of a clear, slightly opalescent, low-viscosity liquid.

2.5 g of an etherified melamine resin (Luwipal 063), preheated to 60° C., were added to this catalyst-comprising microemulsion. After 30 minutes at 60° C., a slightly cloudy, highly viscous gel formed and was freeze-dried to remove the pentane.

### Example 3

Mixing of 10 g of pentane, 1.0 g of Lutensol TO7, 1.2 g of 2,4-diamino-6-nonyl-1,3,5-triazine, 0.1 g of NH₄Cl and 16 g of 2% by weight aqueous phosphoric acid at 60° C. gave a microemulsion in the form of a clear, slightly opalescent, low-viscosity liquid.

2.5 g of an etherified melamine resin (Luwipal 063), preheated to 60° C., were added to this catalyst-comprising microemulsion. After 20 minutes at 60° C., a slightly cloudy, highly viscous gel formed and was freeze-dried to remove the pentane.

### Example 4

Mixing of 10 g of pentane, 2.0 g of 2,4-diamino-6-nonyl-1,3,5-triazine, 0.2 g of NH₄Cl and 15.5 g of 1% by weight aqueous hydrochloric acid at 65° C. gave a microemulsion in the form of a clear, slightly opalescent, low-viscosity liquid.

0.5 g of an etherified melamine resin (Luwipal 063) preheated to 65° C. and 1 g of a 37% formalin solution were added to this catalyst-comprising microemulsion. After 10 minutes at 65° C., a slightly cloudy, highly viscous gel formed and was freeze-dried to remove the pentane.

### Example 5

Mixing of 13.5 g of heptane, 1.3 g of Lutensit A-BO and 3 g of 10% by weight aqueous Kauramin 711 solution at 50° C. gave a Microemulsion in the form of a clear, slightly opalescent, low-viscosity liquid. After 30 minutes, a slightly cloudy, highly viscous gel formed and was dried at room temperature and standard pressure to remove the heptane.

1. A nanoporous polymer foam, obtainable by a process comprising curing microemulsions which comprise at least one aqueous polycondensation-reactive resin, at least one oil component and at least one amphiphile, and subsequently drying.

2. The nanoporous polymer foam according to claim 1, wherein the microemulsion comprises, as the polycondensation-reactive resin, an amino resin.

3. The nanoporous polymer foam according to claim 2, wherein the amino resin is a urea-formaldehyde, benzoguanamine-formaldehyde or melamine-formaldehyde resin.

4. The nanoporous polymer foam according to claim 1, wherein the microemulsion comprises at least one reactive amphiphile.

5. The nanoporous polymer foam according to claim 1, wherein the oil phase comprises a hydrocarbon, alcohol, ketone, ether or alkyl ester, or a mixture of the substances mentioned having a boiling point at atmospheric pressure below 120° C.

6. The nanoporous polymer foam according to claim 1, wherein the bulk density is in the range from 5 to 200 g/l.

7. The nanoporous polymer foam according to claim 1, wherein the average pore diameter is in the range from 10 to 1000 nm, preferably from 30 to 300 nm.

8. A process for producing nanoporous polymer foams, comprising the stages of
a. providing a polycondensation-reactive resin,
b. preparing a microemulsion comprising an oil phase, an amphiphile and an aqueous solution of a curing agent and/or curing catalyst for the polycondensation-reactive resin,
c. combining the solution of the polycondensation-reactive resin from stage a) with the microemulsion from stage b) and curing the reactive components, and
d. drying to obtain the structure of the cured microemulsion.

9. The process according to claim 8, wherein a urea-formaldehyde or melamine-formaldehyde resin is used as the polycondensation resin.

10. The process according to claim claim 8, wherein the microemulsion comprises at least one reactive amphiphile.

11. The process according to claim 8, wherein an organic or inorganic acid is used as the curing catalyst.

12. The process according to claim 8, wherein the oil phase used is a hydrocarbon, alcohol, ketone, ether or alkyl ester, or mixture thereof having a boiling point at atmospheric pressure below 120° C., and the oil phase is removed by evaporation.

13. The nanoporous polymer foam according to claim 2, wherein the oil phase comprises a hydrocarbon, alcohol, ketone, ether or alkyl ester, or a mixture of the substances mentioned having a boiling point at atmospheric pressure below 120° C.

14. The nanoporous polymer foam according to claim 3, wherein the oil phase comprises a hydrocarbon, alcohol, ketone, ether or alkyl ester, or a mixture of the substances mentioned having a boiling point at atmospheric pressure below 120° C.

15. The nanoporous polymer foam according to claim 4, wherein the oil phase comprises a hydrocarbon, alcohol, ketone, ether or alkyl ester, or a mixture of the substances mentioned having a boiling point at atmospheric pressure below 120° C.

16. The nanoporous polymer foam according to claim 2, wherein the bulk density is in the range from 5 to 200 g/l.

17. The nanoporous polymer foam according to claim 3, wherein the bulk density is in the range from 5 to 200 g/l.

18. The nanoporous polymer foam according to claim 4, wherein the bulk density is in the range from 5 to 200 g/l.

19. The nanoporous polymer foam according to claim 5, wherein the bulk density is in the range from 5 to 200 g/l.

20. The nanoporous polymer foam according to claim 2, wherein the average pore diameter is in the range from 10 to 1000 nm, preferably from 30 to 300 nm.
